(19) United States
(12) Patent Application Publication
(10) Pub. No.: US 2026/0112605 A1
(43) Pub. Date: Apr. 23, 2026

(54) TERNARY ALUMINUM-BASED FOIL ANODES FOR SOLID-STATE BATTERIES

(71) Applicant: Georgia Tech Research Corporation, Atlanta, GA (US)

(72) Inventors: Matthew T. McDowell, Atlanta, GA (US); Congcheng Wang, Atlanta, GA (US); Sazol Das, Atlanta, GA (US); Raj Gopalaswamy, Atlanta, GA (US); Diptarka Majmudar, Atlanta, GA (US)

(21) Appl. No.: 19/362,875

(22) Filed: Oct. 20, 2025

Related U.S. Application Data
(60) Provisional application No. 63/709,817, filed on Oct. 21, 2024.

(51) Int. Cl. H01M 4/134; H01M 4/02; H01M 10/0525

(52) U.S. Cl. CPC H01M 4/134; H01M 10/0525; H01M 2004/027

(57) ABSTRACT

The present disclosure provides a multiphase foil anode for a solid-state battery, comprising a foil with aluminum as a majority phase and secondary phases dispersed within the aluminum majority phase, wherein the secondary phases comprise at least two different elements selected from indium, lead, bismuth, tin, gallium, zinc, lithium, and silicon. The multiphase foil anode exhibits enhanced lithium storage capacity and cycling performance in solid-state battery applications.

### CROSS-REFERENCE TO RELATED APPLICATIONS

This application claims priority to U.S. Provisional Application No. 63/709,817, titled Ternary Aluminum-Based Foil Anodes for Solid-State Batteries, filed 21 Oct. 2024, which is hereby incorporated by reference in its entirety.

### FIELD OF INVENTION

The present disclosure relates to battery anode materials for solid-state batteries, and more particularly to multiphase aluminum-based foil anodes comprising aluminum with secondary alloying elements for enhanced lithium storage and cycling performance.

### BACKGROUND

Solid-state batteries represent an emerging technology that offers potential safety advantages over conventional lithium-ion batteries while enabling the use of new electrode materials that could increase energy density and specific energy. These battery systems feature an active cathode material, a solid-state ion-conducting separator, and an active anode material, with lithium ions traveling between the cathode and anode during charge and discharge cycles.

Current research in solid-state battery technology focuses primarily on two main approaches for anode materials: pure lithium metal anodes and composite anodes containing active materials mixed with inactive solid-state ion-conducting materials. While lithium metal shows promise as an anode material, it presents substantial challenges due to the formation of short circuits that can cause battery failure. Composite anodes that incorporate inactive solid electrolyte materials suffer from reduced energy density because of the excess inactive material content.

Aluminum-based materials have attracted attention as potential anode materials due to their favorable properties, including high theoretical capacity, light weight, earth abundance, and low cost. The ability to manufacture aluminum-based foils also offers potential advantages for simplifying battery manufacturing processes. However, the utilization of aluminum anodes can experience performance challenges during charge and discharge cycling.

The development of new electrode concepts that can enable high energy density while being easily manufactured at large scales remains an area of ongoing research. Various approaches have been explored to improve the cycling performance of aluminum-based anodes, including the development of aluminum alloys and composite foil structures with different compositions and morphologies.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a multiphase foil anode for a solid-state battery is provided. The multiphase foil anode comprises a foil comprising aluminum as a majority phase. The multiphase foil anode comprises a plurality of secondary phases dispersed within the aluminum majority phase, wherein the plurality of secondary phases comprises at least two different elements selected from the group consisting of indium, lead, bismuth, tin, gallium, zinc, lithium, and silicon.

According to other aspects of the present disclosure, the multiphase foil anode may include one or more of the following features. The aluminum majority phase may comprise at least 90 weight percent of the foil. The aluminum majority phase may comprise at least 95 weight percent of the foil. The plurality of secondary phases may comprise indium and lead. The foil may comprise aluminum in an amount of 95 weight percent, indium in an amount of 2.5 weight percent, and lead in an amount of 2.5 weight percent. The plurality of secondary phases may comprise indium and silicon. At least one element of the plurality of secondary phases may alloy with lithium at a redox potential higher than aluminum.

According to another aspect of the present disclosure, a multiphase aluminum-based foil anode for a solid-state battery is provided. The multiphase aluminum-based foil anode comprises an aluminum matrix forming a majority phase of the foil. The multiphase aluminum-based foil anode comprises indium particles dispersed within the aluminum matrix. The multiphase aluminum-based foil anode comprises lead particles dispersed within the aluminum matrix, wherein the aluminum comprises at least 90 atomic percent of the foil composition.

According to other aspects of the present disclosure, the multiphase aluminum-based foil anode may include one or more of the following features. The aluminum may comprise at least 95 atomic percent of the foil composition. The indium particles may comprise between 1 and 5 atomic percent of the foil composition. The lead particles may comprise between 1 and 5 atomic percent of the foil composition. The indium particles may comprise 2.5 atomic percent and the lead particles may comprise 2.5 atomic percent of the foil composition. The indium particles and lead particles may form secondary phases with an interconnected laminar structure within the aluminum matrix. The indium and lead may alloy with lithium at redox potentials higher than aluminum.

According to another aspect of the present disclosure, a solid-state battery is provided. The solid-state battery comprises a cathode comprising an active cathode material. The solid-state battery comprises a solid-state electrolyte. The solid-state battery comprises a multiphase foil anode comprising aluminum as a majority phase and at least two secondary alloying elements selected from indium, lead, bismuth, tin, gallium, zinc, lithium, and silicon.

According to other aspects of the present disclosure, the solid-state battery may include one or more of the following features. The at least two secondary alloying elements may comprise indium and lead. The multiphase foil anode may comprise lead in an amount of up to 4 weight percent. The multiphase foil anode may comprise indium in an amount of up to 2.5 weight percent. The multiphase foil anode may comprise aluminum in an amount of 95 weight percent, indium in an amount of 2.5 weight percent, and lead in an amount of 2.5 weight percent. The multiphase foil anode may exhibit an initial Coulombic efficiency of at least 80%.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF FIGURES

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 depicts a schematic diagram of a multiphase foil, according to aspects of the present disclosure.

FIG. 2A depicts performance data showing capacity and efficiency measurements for an aluminum-indium-lead alloy battery anode, according to aspects of the present disclosure.

FIG. 2B depicts voltage versus areal capacity curves for the aluminum-indium-lead alloy battery anode of FIG. 2A, according to aspects of the present disclosure.

FIG. 2C depicts performance data showing capacity and efficiency measurements for an aluminum-indium-lead alloy battery anode, according to aspects of the present disclosure.

FIG. 2D depicts voltage versus areal capacity curves for the aluminum-indium-lead alloy battery anode of FIG. 2C, according to aspects of the present disclosure.

FIG. 3A depicts performance data showing capacity and efficiency measurements for an aluminum-indium battery anode, according to aspects of the present disclosure.

FIG. 3B depicts voltage versus areal capacity curves for the aluminum-indium alloy battery anode of FIG. 3A, according to aspects of the present disclosure.

FIG. 3C depicts performance data showing capacity and efficiency measurements for an aluminum-indium-lead composition, according to aspects of the present disclosure.

FIG. 3D depicts voltage versus areal capacity curves for the aluminum-indium-lead alloy battery anode of FIG. 3C, according to aspects of the present disclosure.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the”include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The term “multiphase” is used herein to mean comprising multiple distinct phases or regions of different material compositions within a single foil structure. A multiphase foil contains a majority phase (and in some cases, a plurality phase, e.g., less or equal to 50%) of one material with secondary phases of different materials dispersed throughout, where each phase maintains its distinct chemical and physical properties while contributing to the overall performance characteristics of the composite structure.

A multiphase foil anode for a solid-state battery may comprise a foil comprising aluminum as a majority phase and a plurality of secondary phases dispersed within the aluminum majority phase. The aluminum majority phase may form the primary structural matrix of the foil, providing mechanical stability and serving as an active material that alloys with lithium during battery operation. The plurality of secondary phases may be distributed throughout the aluminum matrix to enhance various performance characteristics of the anode.

The plurality of secondary phases may comprise at least two different elements selected from the group consisting of indium, lead, bismuth, tin, gallium, zinc, lithium, and silicon. Each of these elements may contribute distinct properties to the multiphase foil anode. In some cases, the secondary phase elements may be selected based on their lithium diffusivity characteristics, redox potential relative to aluminum, lithium storage capacity, or mechanical properties such as deformability.

In some cases, the aluminum majority phase may comprise at least 90 weight percent of the foil, and in certain configurations, may comprise at least 95 weight percent of the foil. The remaining weight percentage may be distributed among the plurality of secondary phases. The secondary phases may be present as discrete particles, regions, or interconnected structures within the aluminum matrix, depending on the specific composition and processing conditions used to form the multiphase foil.

The selection of secondary phase elements may be based on multiple material properties that contribute to battery performance. Elements with high lithium diffusivity in the lithiated state, such as bismuth or indium, may help overcome diffusional lithium trapping that can occur during battery cycling. Elements that alloy with lithium at redox potentials higher than aluminum, such as bismuth, indium, and tin, may remain lithiated during the alloying and dealloying processes of aluminum, potentially improving cycling stability. Elements with high specific lithium storage capacity, such as silicon, may increase the overall energy storage capability of the anode. Additionally, elements that are soft and deformable, such as indium, lead, and tin, may form secondary phases with interconnected laminar structures that accommodate volume changes during lithium insertion and extraction.

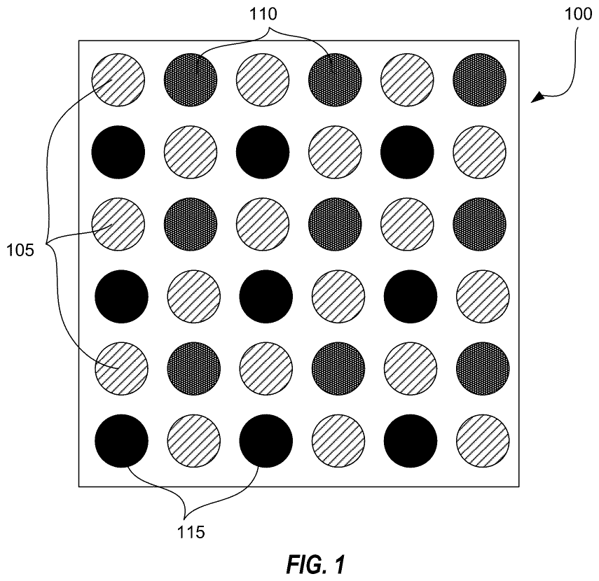

Referring to FIG. 1, a multiphase foil 100 may comprise a detailed structure that includes aluminum particles 105 forming an aluminum matrix as the majority phase, with indium particles 110 and lead particles 115 dispersed within the aluminum matrix. The multiphase foil 100 may demonstrate the distribution of different particle types throughout a single foil structure, where each type of particle contributes distinct properties to the overall anode performance.

The aluminum particles 105 may form the primary structural framework of the multiphase foil 100, providing mechanical integrity and serving as the majority phase material. In some cases, the aluminum matrix may comprise at least 90 weight percent of the foil composition, and in certain configurations, may comprise at least 95 weight percent of the foil. The aluminum content may vary across different compositions, with some configurations comprising aluminum in amounts of at least 50%, 64% 90%, 92%, 94%, or 95% by weight (among other amounts), depending on the specific application requirements and desired performance characteristics.

As shown in FIG. 1, the indium particles 110 (or other secondary phase material particles) may be dispersed throughout the aluminum matrix formed by the aluminum particles 105. The indium particles 110 (or other secondary phase material particles) may be present in various concentrations within the multiphase foil 100. In some cases, the indium particles 110 (or other secondary phase material particles) may comprise up to 1%, 2.5%, 3%, 4%, 5%, or 10% by weight of the foil composition. The distribution of the indium particles 110 within the aluminum matrix may provide enhanced lithium diffusivity and contribute to improved cycling performance of the anode.

The lead particles 115 (or other secondary phase material particles) may also be dispersed within the aluminum matrix, as illustrated in FIG. 1. The lead particles 115 (or other secondary phase material particles) may be present in amounts of up to 1%, 2.5%, 3%, 4%, 5%, or 10% by weight of the foil composition. The lead particles 115 may contribute to the mechanical deformability of the multiphase foil 100 and may help accommodate volume changes that occur during lithium insertion and extraction processes.

With continued reference to FIG. 1, the multiphase foil 100 may include alternative secondary phase materials beyond the indium particles 110 and lead particles 115. In some cases, bismuth particles may be dispersed within the aluminum matrix as secondary phases, providing high lithium diffusivity characteristics. Tin particles may also serve as secondary phases within the aluminum matrix, offering redox potentials higher than aluminum and contributing to cycling stability.

The multiphase foil 100 may further include gallium particles as secondary phases dispersed within the aluminum matrix. Gallium particles may alloy with lithium and contribute to the overall electrochemical performance of the anode. Additionally, zinc particles may be incorporated as secondary phases within the aluminum matrix, providing additional alloying capabilities with lithium.

In certain configurations, lithium alloy particles may be present as secondary phases dispersed within the aluminum matrix of the multiphase foil 100. The lithium alloy particles may serve as a lithium source and may enhance the initial lithiation characteristics of the anode. Silicon particles may also be included as secondary phases within the aluminum matrix, providing high specific lithium storage capacity and contributing to increased energy density of the anode.

The various particle types shown in FIG. 1 may be distributed uniformly throughout the multiphase foil 100, though the specific arrangement may vary depending on processing conditions and composition ratios. The secondary phase particles may form interconnected structures or remain as discrete particles within the aluminum matrix, depending on the specific elements used and their concentrations within the foil composition.

The selection of secondary phase elements for the multiphase foil anode may be based on specific material properties that enhance battery performance through multiple mechanisms. The secondary phase elements may be chosen according to criteria that address lithium transport, energy storage capacity, mechanical accommodation of volume changes, and electrochemical compatibility with the aluminum matrix.

Secondary phase elements with high lithium diffusivity in the lithiated state may be selected to overcome diffusional lithium trapping that can occur during battery operation. Diffusional lithium trapping may limit the rate at which lithium ions can move through the anode material, potentially reducing battery performance and cycling efficiency. Elements such as bismuth and indium may exhibit high lithium diffusivity characteristics in the lithiated state, allowing lithium ions to move more readily through the anode structure. The incorporation of these high-diffusivity elements as secondary phases may facilitate lithium transport pathways within the multiphase foil anode, reducing transport limitations and improving overall electrochemical performance.

The selection criteria may also include elements with high specific lithium storage capacity to maximize the energy storage capability of the anode. Silicon may serve as an example of a secondary phase element with high specific lithium storage capacity, capable of storing significantly more lithium per unit mass compared to aluminum alone. The incorporation of high-capacity elements as secondary phases may increase the overall lithium storage capability of the multiphase foil anode without compromising the structural integrity provided by the aluminum matrix.

Secondary phase elements may be selected based on their mechanical properties, particularly their softness and deformability characteristics. Soft and deformable elements such as indium, lead, and tin may accommodate the volume changes that occur during lithium insertion and extraction processes. These elements may form secondary phases with an interconnected laminar structure within the aluminum matrix, providing mechanical flexibility that helps maintain structural integrity during battery cycling. The interconnected laminar structure may distribute mechanical stresses more effectively throughout the anode, reducing the likelihood of crack formation or structural failure during repeated charge and discharge cycles.

At least one element of the plurality of secondary phases may alloy with lithium at a redox potential higher than aluminum. Elements that alloy with lithium at redox potentials higher than aluminum may remain lithiated during the alloying and dealloying processes of aluminum, potentially providing electrochemical stability and improved cycling performance. This electrochemical characteristic may help maintain the structural and chemical integrity of the secondary phases throughout battery operation.

Indium and lead may alloy with lithium at redox potentials higher than aluminum, making these elements suitable choices for secondary phases in the multiphase aluminum-based foil anode. The higher redox potentials of indium and lead relative to aluminum may allow these elements to maintain their lithiated states during portions of the battery cycling process when aluminum undergoes dealloying. This electrochemical behavior may contribute to the stability of the secondary phase structure and may help preserve the interconnected laminar structure formed by the indium particles and lead particles within the aluminum matrix during battery operation.

The multiphase foil anode may comprise specific compositional ranges that provide enhanced electrochemical performance in solid-state battery applications. In some cases, the foil may comprise aluminum in an amount of 95 weight percent, indium in an amount of 2.5 weight percent, and lead in an amount of 2.5 weight percent. This particular composition may provide a balance between the structural stability provided by the aluminum majority phase and the performance enhancements contributed by the indium and lead secondary phases.

The 95 weight percent aluminum content may maintain the mechanical integrity and primary electrochemical functionality of the anode while allowing sufficient secondary phase content to achieve performance improvements. The 2.5 weight percent indium content may provide enhanced lithium diffusivity characteristics without compromising the overall structural framework of the foil. Similarly, the 2.5 weight percent lead content may contribute mechanical deformability and volume change accommodation capabilities while maintaining compatibility with the aluminum matrix.

Alternative compositional configurations may include the plurality of secondary phases comprising indium and silicon. In such configurations, the silicon secondary phase may provide high specific lithium storage capacity, while the indium secondary phase may contribute enhanced lithium diffusivity characteristics. The combination of indium and silicon as secondary phases may offer complementary performance benefits, with silicon increasing the overall energy storage capability and indium facilitating lithium transport within the anode structure.

The multiphase aluminum-based foil anode may include indium particles that comprise between 1 and 5 atomic percent of the foil composition. This compositional range may provide flexibility in tailoring the anode performance characteristics based on specific application requirements. Lower indium concentrations within this range may provide moderate improvements in lithium diffusivity while maintaining the predominant aluminum matrix characteristics. Higher indium concentrations within this range may offer more pronounced enhancements in lithium transport properties.

In some cases, the lead particles may comprise between 1 and 5 atomic percent of the foil composition. This compositional range for lead particles may allow for optimization of the mechanical deformability characteristics of the multiphase aluminum-based foil anode. Lead concentrations at the lower end of this range may provide modest improvements in volume change accommodation, while higher lead concentrations may offer more substantial mechanical flexibility during battery cycling operations.

A specific compositional example of the multiphase aluminum-based foil anode may include indium particles that comprise 2.5 atomic percent and lead particles that comprise 2.5 atomic percent of the foil composition. This balanced composition may provide an optimal combination of enhanced lithium diffusivity from the indium particles and improved mechanical deformability from the lead particles. The equal atomic percentages of indium and lead may create a synergistic effect where both secondary phases contribute complementary performance enhancements without one element dominating the secondary phase characteristics.

The compositional ranges and specific examples may be achieved through various manufacturing processes that allow for precise control of element distribution and concentration within the multiphase foil structure. The atomic percentages of secondary phase elements may be controlled during foil formation to achieve the desired balance of electrochemical and mechanical properties for specific solid-state battery applications.

A solid-state battery may comprise a cathode comprising an active cathode material, a solid-state electrolyte, and a multiphase foil anode comprising aluminum as a majority phase and at least two secondary alloying elements selected from indium, lead, bismuth, tin, gallium, zinc, lithium, and silicon. The solid-state battery configuration may provide enhanced safety characteristics compared to conventional lithium-ion batteries while enabling the use of new electrode materials that can increase energy density and specific energy.

The cathode comprising an active cathode material may serve as the positive electrode in the solid-state battery system. The active cathode material may store lithium ions during battery operation and may release lithium ions during discharge cycles. In some cases, the active cathode material may comprise lithium nickel cobalt manganese oxide (LiNi_{0.6}Co_{0.2}Mn_{0.2}O₂) or other lithium-containing compounds capable of reversible lithium ion storage and release. The cathode may be configured to operate at specific loading conditions, such as cathode loadings of 5 mAh cm⁻², to achieve desired energy density characteristics.

The solid-state electrolyte may be positioned between the cathode and the multiphase foil anode to facilitate lithium ion transport during battery operation. The solid-state electrolyte may comprise materials such as lithium phosphorus sulfide chloride (Li₆PS₅Cl) or other solid-state ion-conducting materials. The solid-state electrolyte may provide ionic conductivity while maintaining electrical isolation between the cathode and anode. In some cases, the solid-state electrolyte may operate under specific pressure conditions, such as stack pressures of 5-50 MPa, to maintain proper contact and ionic conductivity between battery components.

The multiphase foil anode may serve as the negative electrode in the solid-state battery system and may comprise aluminum as a majority phase with at least two secondary alloying elements dispersed throughout the aluminum matrix. The multiphase foil anode may provide lithium storage capability through alloying and dealloying processes that occur during battery charging and discharging cycles. The secondary alloying elements may enhance various performance characteristics of the anode, including lithium diffusivity, mechanical deformability, and electrochemical stability.

In some cases, the at least two secondary alloying elements may comprise indium and lead. The combination of indium and lead as secondary alloying elements may provide complementary performance benefits within the solid-state battery system. Indium may contribute enhanced lithium diffusivity characteristics that facilitate lithium ion transport within the anode structure, while lead may provide mechanical deformability that accommodates volume changes during lithium insertion and extraction processes.

The multiphase foil anode may comprise lead in an amount of up to 4 weight percent. This lead content range may allow for optimization of the mechanical properties of the anode while maintaining compatibility with the aluminum majority phase and the solid-state electrolyte. Lead concentrations within this range may provide sufficient mechanical deformability to accommodate volume changes during battery cycling without compromising the structural integrity of the multiphase foil anode or interfering with the solid-state electrolyte interface.

The multiphase foil anode may comprise indium in an amount of up to 5 weight percent. This indium content range may provide enhanced lithium diffusivity characteristics within the solid-state battery system while maintaining the predominant aluminum matrix properties. Indium concentrations within this range may facilitate lithium ion transport between the solid-state electrolyte and the aluminum majority phase, potentially improving the rate capability and cycling efficiency of the solid-state battery.

In certain configurations, the multiphase foil anode may comprise aluminum in an amount of 95 weight percent, indium in an amount of 2.5 weight percent, and lead in an amount of 2.5 weight percent. This specific composition may provide a balanced combination of structural stability from the aluminum majority phase and performance enhancements from the indium and lead secondary alloying elements within the solid-state battery system. The 95 weight percent aluminum content may maintain the primary electrochemical functionality and mechanical framework of the anode, while the 2.5 weight percent indium and 2.5 weight percent lead contents may contribute complementary improvements in lithium transport and mechanical accommodation properties.

The solid-state battery system may operate under specific conditions that optimize the performance of the multiphase foil anode in combination with the cathode and solid-state electrolyte. Operating temperatures may be maintained at ambient conditions, such as 25° C., to ensure stable electrochemical performance of all battery components. Current density conditions may vary during different phases of battery operation, with lower current densities such as 0.2 mA cm⁻² used for initial cycles and higher current densities such as 1 mA cm⁻² used for subsequent cycling operations.

The multiphase foil anode within the solid-state battery system may exhibit an initial Coulombic efficiency of at least 80%. The initial Coulombic efficiency may represent the ratio of discharge capacity to charge capacity during the first cycle of battery operation and may indicate the effectiveness of lithium utilization within the anode structure. Initial Coulombic efficiencies of at least 80% may demonstrate that the multiphase foil anode can effectively store and release lithium ions in combination with the solid-state electrolyte and cathode components, indicating good electrochemical compatibility and performance within the solid-state battery system.

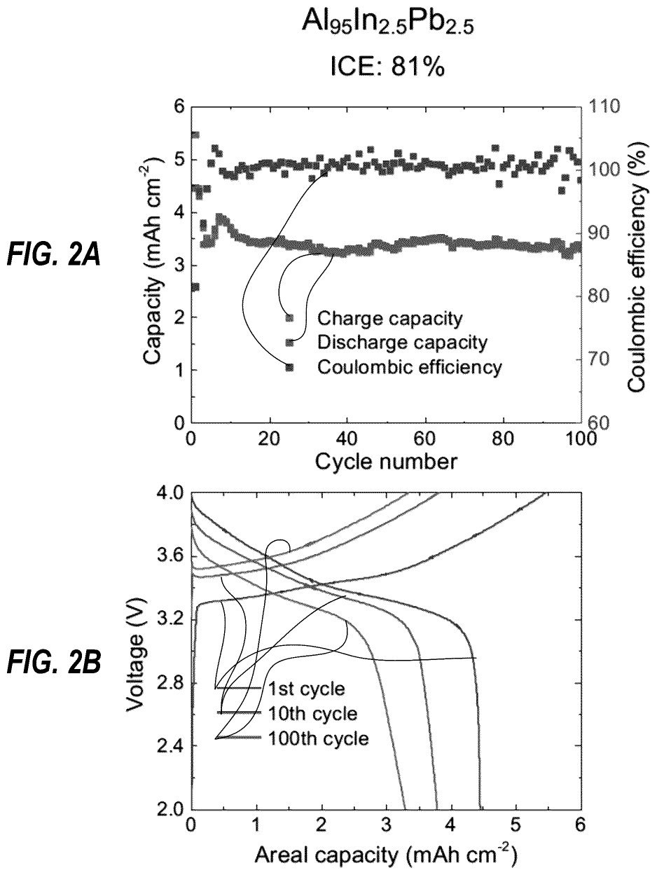

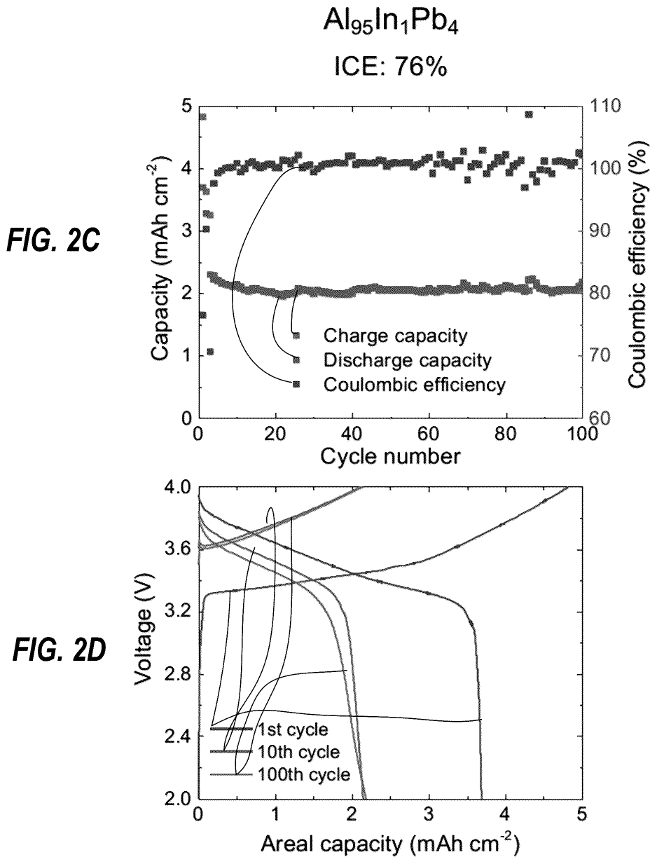

Referring to FIG. 2A, the Al₉₅In_{2.5}Pb_{2.5} composition may demonstrate specific performance characteristics during galvanostatic testing in a solid-state battery configuration. FIG. 2A may show charge capacity, discharge capacity, and Coulombic efficiency measurements plotted against cycle number over approximately 100 cycles. The multiphase foil anode with this composition may exhibit stable cycling behavior with consistent capacity retention throughout the testing period.

The Al₉₅In_{2.5}Pb_{2.5} composition may achieve an initial Coulombic efficiency of 81% during the first cycle of operation. This initial Coulombic efficiency value may indicate the effectiveness of lithium utilization within the multiphase foil anode structure during the initial lithiation and delithiation processes. The 81% initial Coulombic efficiency may demonstrate that the secondary phases of indium and lead contribute to improved electrochemical performance compared to pure aluminum anodes.

As shown in FIG. 2A, the discharge capacity of the Al₉₅In_{2.5}Pb_{2.5} composition may stabilize at approximately 2 mAh cm⁻² after initial cycling. The charge capacity may track closely with the discharge capacity throughout the cycling period, indicating consistent electrochemical reversibility of the lithium alloying and dealloying processes within the multiphase foil anode. The Coulombic efficiency may approach approximately 100% during subsequent cycles after the initial formation cycles, demonstrating stable electrochemical performance.

With continued reference to FIG. 2A, the cycling stability of the Al₉₅In_{2.5}Pb_{2.5} composition may be maintained over extended cycling periods. The capacity retention characteristics shown in FIG. 2A may indicate that the indium and lead secondary phases provide structural stability that accommodates volume changes during lithium insertion and extraction processes. The stable cycling behavior may result from the mechanical deformability contributed by the lead particles and the enhanced lithium diffusivity provided by the indium particles within the aluminum matrix.

Referring to FIG. 2B, the voltage versus areal capacity curves for the Al₉₅In_{2.5}Pb_{2.5} composition may demonstrate the electrochemical behavior during charge and discharge processes. FIG. 2B may show voltage profiles for the 1st, 10th, and 100th cycles, with voltage ranging from approximately 2.0 to 4.0 V and areal capacity extending from 0 to 6 mAh cm⁻². The voltage profiles may indicate the lithium alloying and dealloying processes occurring within the multiphase foil anode during battery operation.

The voltage curves shown in FIG. 2B may demonstrate consistent electrochemical behavior across different cycle numbers, indicating stable performance of the Al₉₅In_{2.5}Pb_{2.5} composition over extended cycling. The voltage plateaus and transitions observed in the curves may correspond to specific lithium alloying reactions with aluminum, indium, and lead within the multiphase foil anode structure. The consistency of these voltage characteristics across cycles may indicate that the secondary phases maintain their electrochemical activity and structural integrity throughout battery operation.

The multiphase foil anode may exhibit initial Coulombic efficiency values that vary depending on the specific composition of secondary alloying elements. Various tested compositions may demonstrate initial Coulombic efficiency values of 76%, 81%, 82.4%, and 83.7%. These initial Coulombic efficiency values may indicate that different combinations and concentrations of secondary alloying elements can achieve performance levels that meet or exceed the threshold of at least 80% initial Coulombic efficiency.

The Al₉₅In₁Pb₄ composition may achieve an initial Coulombic efficiency of 76%, demonstrating that compositions with higher lead content and lower indium content can provide functional electrochemical performance. The Al₉₅In_{2.5}Pb_{2.5} composition may achieve initial Coulombic efficiency values of both 81% and 82.4% in different test configurations, indicating reproducible performance characteristics. The Al₉₅In₅ composition may achieve an initial Coulombic efficiency of 83.7%, demonstrating that binary aluminum-indium compositions can also achieve high initial Coulombic efficiency values.

The range of initial Coulombic efficiency values from 76% to 83.7% may demonstrate the flexibility of the multiphase foil anode design in achieving performance characteristics suitable for solid-state battery applications. The multiphase foil anode compositions that achieve initial Coulombic efficiency values of at least 80% may provide enhanced electrochemical performance that contributes to improved battery efficiency and cycling stability in solid-state battery systems.

Referring to FIG. 2C, the Al₉₅In₁Pb₄ composition may demonstrate specific performance characteristics during galvanostatic testing in a solid-state battery configuration. FIG. 2C may show capacity and Coulombic efficiency measurements plotted against cycle number over approximately 100 cycles. The multiphase foil anode with this composition may exhibit stable cycling behavior with the discharge capacity stabilizing around 2 mAh cm⁻² throughout the testing period.

The Al₉₅In₁Pb₄ composition may achieve an initial Coulombic efficiency of 76% during the first cycle of operation. This initial Coulombic efficiency value may indicate the electrochemical performance of the multiphase foil anode structure with a higher lead content and lower indium content compared to other tested compositions. The 76% initial Coulombic efficiency may demonstrate that compositions with increased lead concentrations can provide functional electrochemical performance within solid-state battery systems.

As shown in FIG. 2C, the Coulombic efficiency of the Al₉₅In₁Pb₄ composition may maintain approximately 100% throughout the cycling period after the initial formation cycles. The consistent Coulombic efficiency values may indicate stable electrochemical reversibility of the lithium alloying and dealloying processes within the multiphase foil anode. The charge capacity and discharge capacity may track closely together throughout the 100-cycle testing period, demonstrating reliable electrochemical performance.

With continued reference to FIG. 2C, the cycling stability of the Al₉₅In₁Pb₄ composition may be maintained over the extended testing period without significant capacity degradation. The stable capacity retention characteristics shown in FIG. 2C may indicate that the higher lead content provides mechanical accommodation for volume changes during lithium insertion and extraction processes. The 4% lead content may contribute enhanced mechanical deformability that helps maintain structural integrity during repeated charge and discharge cycles.

Referring to FIG. 2D, the voltage profiles for the Al₉₅In₁Pb₄ composition may demonstrate consistent electrochemical behavior during charge and discharge operations. FIG. 2D may display voltage profiles plotted against areal capacity for the 1st, 10th, and 100th cycles, with voltage ranging between approximately 2.0 and 4.0 V. The voltage curves may show the electrochemical processes occurring within the multiphase foil anode during battery operation.

The voltage profiles shown in FIG. 2D may demonstrate stable electrochemical characteristics across different cycle numbers, indicating consistent performance of the Al₉₅In₁Pb₄ composition throughout extended cycling. The voltage behavior observed in the curves may correspond to lithium alloying reactions with aluminum, indium, and lead within the multiphase foil anode structure. The consistency of the voltage profiles between the 1st, 10th, and 100th cycles may indicate that the secondary phases maintain their electrochemical activity and structural stability during battery operation.

As further shown in FIG. 2D, the areal capacity characteristics of the Al₉₅In₁Pb₄ composition may remain consistent across the tested cycles. The voltage versus areal capacity relationship may demonstrate that the multiphase foil anode maintains its lithium storage capability throughout the cycling period. The stable voltage behavior may result from the combined effects of the 1% indium content providing lithium diffusivity enhancement and the 4% lead content contributing mechanical stability within the aluminum matrix.

The Al₉₅In₁Pb₄ composition may demonstrate that variations in the ratio of indium to lead content can achieve stable electrochemical performance while maintaining the aluminum majority phase characteristics. The higher lead concentration in this composition compared to the Al₉₅In_{2.5}Pb_{2.5} composition may provide different mechanical and electrochemical properties while still achieving functional battery performance. The performance characteristics shown in FIG. 2C and FIG. 2D may indicate that the multiphase foil anode design allows for compositional flexibility in achieving desired battery performance characteristics.

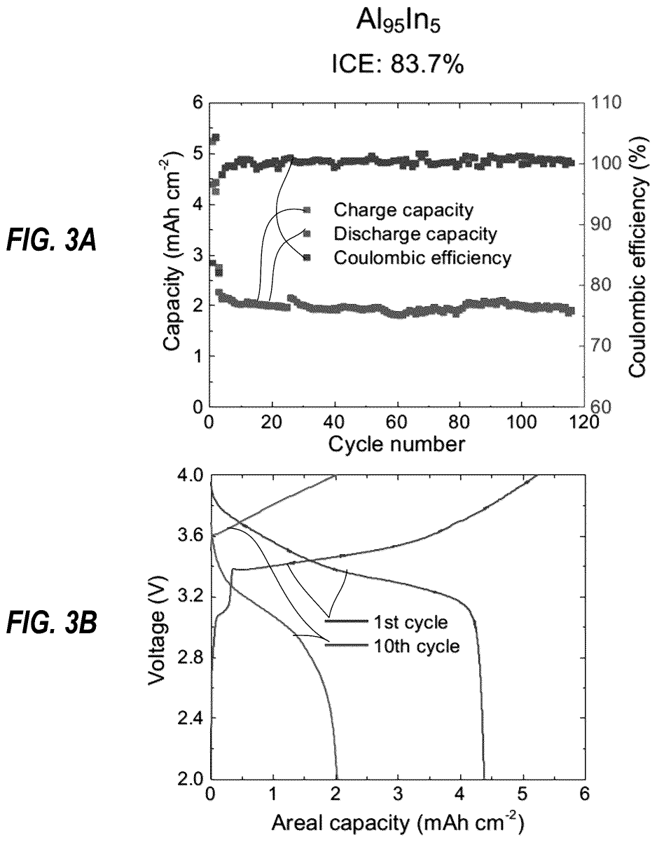

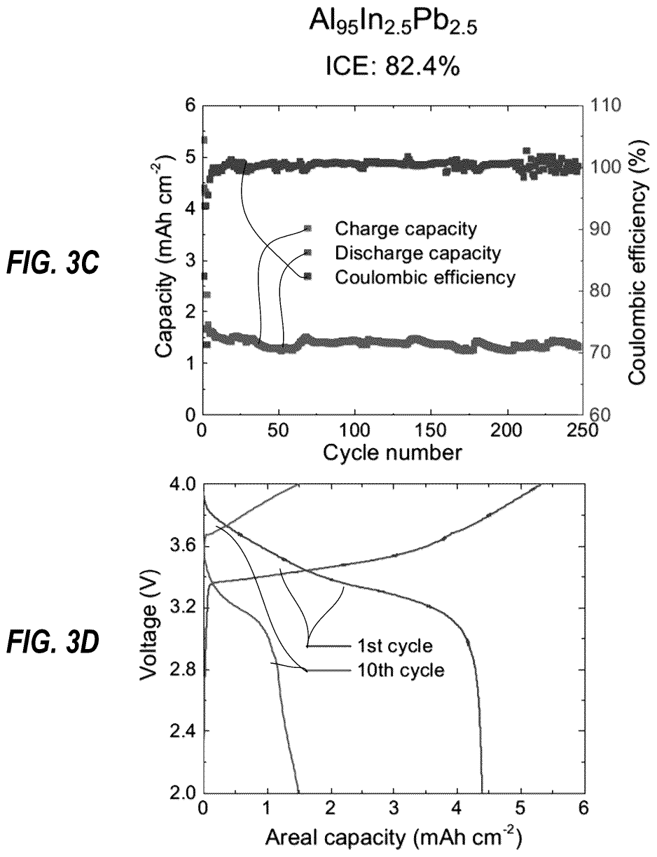

Referring to FIG. 3A, the Al₉₅In₅ composition may demonstrate specific performance characteristics during galvanostatic testing in a solid-state battery configuration. FIG. 3A may show charge capacity, discharge capacity, and Coulombic efficiency measurements plotted against cycle number over approximately 120 cycles. The multiphase foil anode with this binary aluminum-indium composition may exhibit stable cycling behavior throughout the extended testing period.

The Al₉₅In₅ composition may achieve an initial Coulombic efficiency of 83.7% during the first cycle of operation. This initial Coulombic efficiency value may represent the highest performance among the tested compositions, indicating that the 5% indium content provides enhanced electrochemical performance within the multiphase foil anode structure. The 83.7% initial Coulombic efficiency may demonstrate that binary aluminum-indium compositions can achieve superior lithium utilization compared to ternary compositions containing both indium and lead.

As shown in FIG. 3A, the discharge capacity of the Al₉₅In₅ composition may stabilize at approximately 2.5 mAh cm⁻² after initial cycling. The charge capacity may track closely with the discharge capacity throughout the 120-cycle testing period, indicating consistent electrochemical reversibility of the lithium alloying and dealloying processes within the multiphase foil anode. The Coulombic efficiency may approach approximately 100% during subsequent cycles after the initial formation cycles, demonstrating stable long-term electrochemical performance.

With continued reference to FIG. 3A, the cycling stability of the Al₉₅In₅ composition may be maintained over the extended 120-cycle testing period without significant capacity degradation. The capacity retention characteristics shown in FIG. 3A may indicate that the 5% indium content provides sufficient enhancement of lithium diffusivity and electrochemical stability within the aluminum matrix. The stable cycling behavior may result from the enhanced lithium transport properties contributed by the indium secondary phase, which may facilitate more efficient lithium insertion and extraction processes during battery operation.

The Al₉₅In₅ composition may demonstrate that binary aluminum-indium multiphase foil anodes can achieve performance characteristics comparable to or exceeding those of ternary compositions. The absence of lead in this composition may indicate that indium alone can provide sufficient performance enhancement when present at higher concentrations within the aluminum matrix. The 5% indium content may provide enhanced lithium diffusivity characteristics that overcome diffusional lithium trapping without requiring additional secondary phase elements for mechanical deformability.

Referring to FIG. 3B, the voltage versus areal capacity curves for the Al₉₅In₅ composition may demonstrate the electrochemical behavior during charge and discharge processes. FIG. 3B may show voltage profiles for the first cycle and tenth cycle, with voltage ranging from approximately 2.0 to 4.0 V and areal capacity extending from 0 to 6 mAh cm⁻². The voltage profiles may indicate the lithium alloying and dealloying processes occurring within the binary aluminum-indium multiphase foil anode during battery operation.

The voltage curves shown in FIG. 3B may demonstrate consistent electrochemical behavior between the first and tenth cycles, indicating stable performance of the Al₉₅In₅ composition during initial cycling periods. The voltage plateaus and transitions observed in the curves may correspond to specific lithium alloying reactions with aluminum and indium within the multiphase foil anode structure. The consistency of these voltage characteristics between the first and tenth cycles may indicate that the indium secondary phase maintains its electrochemical activity and structural integrity during the initial battery operation cycles.

As further shown in FIG. 3B, the areal capacity characteristics of the Al₉₅In₅ composition may demonstrate stable lithium storage capability between the tested cycles. The voltage versus areal capacity relationship may show that the binary aluminum-indium multiphase foil anode maintains consistent electrochemical performance during the transition from initial formation cycles to stable cycling operation. The voltage behavior may result from the enhanced lithium diffusivity provided by the 5% indium content within the aluminum matrix, which may facilitate more efficient lithium transport during charge and discharge processes.

The Al₉₅In₅ composition may demonstrate that binary aluminum-indium multiphase foil anodes can achieve high initial Coulombic efficiency and stable cycling performance without requiring additional secondary phase elements. The performance characteristics shown in FIG. 3A and FIG. 3B may indicate that indium concentrations of 5% within the aluminum matrix can provide sufficient enhancement of electrochemical properties to achieve superior battery performance compared to compositions with lower indium concentrations or ternary compositions with multiple secondary phase elements.

Referring to FIG. 3C, the Al₉₅In_{2.5}Pb_{2.5} composition may demonstrate extended cycling performance characteristics during galvanostatic testing over 250 charge-discharge cycles in a solid-state battery configuration. FIG. 3C may show capacity and Coulombic efficiency measurements plotted against cycle number throughout the extended testing period. The multiphase foil anode with this composition may exhibit stable long-term cycling behavior with consistent capacity retention over the 250-cycle testing duration.

The Al₉₅In_{2.5}Pb_{2.5} composition may achieve an initial Coulombic efficiency of 82.4% during the first cycle of the extended testing period. This initial Coulombic efficiency value may demonstrate the electrochemical performance of the multiphase foil anode structure with balanced indium and lead secondary phase contents during long-term cycling evaluation. The 82.4% initial Coulombic efficiency may indicate effective lithium utilization within the multiphase foil anode structure at the beginning of extended cycling operations.

As shown in FIG. 3C, the discharge capacity of the Al₉₅In_{2.5}Pb_{2.5} composition may maintain approximately 1.5 mAh cm⁻² throughout the 250-cycle testing period. The charge capacity may track closely with the discharge capacity over the extended cycling duration, indicating consistent electrochemical reversibility of the lithium alloying and dealloying processes within the multiphase foil anode. The Coulombic efficiency may remain stable at approximately 100% throughout the majority of the 250-cycle testing period, demonstrating sustained electrochemical performance over extended battery operation.

With continued reference to FIG. 3C, the long-term cycling stability of the Al₉₅In_{2.5}Pb_{2.5} composition may be maintained without significant capacity degradation over the 250-cycle testing period. The capacity retention characteristics shown in FIG. 3C may indicate that the balanced 2.5% indium and 2.5% lead secondary phase contents provide sustained structural stability and electrochemical performance throughout extended cycling operations. The stable cycling behavior over 250 cycles may result from the combined effects of enhanced lithium diffusivity provided by the indium particles and mechanical accommodation of volume changes contributed by the lead particles within the aluminum matrix.

The extended cycling performance shown in FIG. 3C may demonstrate that the Al₉₅In_{2.5}Pb_{2.5} composition can maintain functional electrochemical performance over significantly longer cycling periods than typical battery testing protocols. The 250-cycle testing duration may provide evidence of the long-term viability of the multiphase foil anode design for practical solid-state battery applications. The consistent Coulombic efficiency values approaching 100% throughout the extended testing period may indicate that the secondary phases maintain their structural integrity and electrochemical activity during prolonged battery operation.

Referring to FIG. 3D, the voltage profiles for the Al₉₅In_{2.5}Pb_{2.5} composition may demonstrate consistent electrochemical behavior during the extended cycling evaluation. FIG. 3D may display voltage profiles plotted against areal capacity for the 1st cycle and 10th cycle, with voltage ranging between approximately 2.0 and 4.0 V. The voltage curves may show the electrochemical processes occurring within the multiphase foil anode during the initial phases of the extended cycling test.

The voltage profiles shown in FIG. 3D may demonstrate stable electrochemical characteristics between the first and tenth cycles during the extended cycling evaluation, indicating consistent performance of the Al₉₅In_{2.5}Pb_{2.5} composition throughout the initial cycling period. The voltage behavior observed in the curves may correspond to lithium alloying reactions with aluminum, indium, and lead within the multiphase foil anode structure. The consistency of the voltage profiles between the 1st and 10th cycles may indicate that the secondary phases establish stable electrochemical behavior early in the extended cycling process.

As further shown in FIG. 3D, the areal capacity characteristics of the Al₉₅In_{2.5}Pb_{2.5} composition may demonstrate stable lithium storage capability during the initial cycles of the extended testing period. The voltage versus areal capacity relationship may show that the multiphase foil anode maintains consistent electrochemical performance during the transition from initial formation cycles to stable long-term cycling operation. The voltage behavior may result from the balanced contributions of the 2.5% indium and 2.5% lead secondary phases, which may provide complementary enhancements to lithium transport and mechanical stability within the aluminum matrix.

The voltage profiles in FIG. 3D may provide supporting evidence for the long-term cycling stability demonstrated in FIG. 3C by showing consistent electrochemical behavior during the initial cycles of the extended testing period. The stable voltage characteristics may indicate that the Al₉₅In_{2.5}Pb_{2.5} composition establishes reliable electrochemical processes that can be maintained throughout the 250-cycle testing duration. The combination of stable voltage profiles and sustained capacity retention may demonstrate that the multiphase foil anode design can achieve both short-term electrochemical consistency and long-term cycling durability in solid-state battery applications.

The multiphase foil anode may operate through coordinated interactions between the aluminum majority phase and the secondary phases during charge and discharge cycling in solid-state battery systems. During lithium insertion processes, the aluminum majority phase may undergo alloying reactions with lithium ions to form aluminum-lithium intermetallic compounds. The secondary phases may simultaneously participate in lithium alloying reactions, with each secondary phase element contributing distinct electrochemical and mechanical properties that enhance overall anode performance.

The aluminum majority phase may serve as the primary lithium storage medium during battery charging operations. Lithium ions may migrate from the cathode through the solid-state electrolyte and alloy with aluminum atoms within the majority phase matrix. The aluminum-lithium alloying process may involve the formation of various intermetallic phases, such as LiAl, Li₃Al₂, and Li₉Al₄, depending on the lithium concentration and electrochemical conditions. The aluminum majority phase may provide structural stability during these alloying reactions while accommodating the volume changes associated with lithium insertion.

The secondary phases may enhance lithium storage capacity through complementary alloying mechanisms that occur simultaneously with aluminum-lithium alloying processes. Elements such as silicon within the secondary phases may provide high specific lithium storage capacity through the formation of lithium-silicon compounds, including Li₁₅Si₄ and Li₂₂Si₅. The silicon secondary phases may store significantly more lithium per unit mass compared to aluminum alone, thereby increasing the overall energy storage capability of the multiphase foil anode without compromising the structural framework provided by the aluminum majority phase.

Secondary phase elements with high lithium diffusivity, such as indium and bismuth, may facilitate lithium transport pathways within the multiphase foil anode structure during charge and discharge operations. These elements may create preferential diffusion channels that allow lithium ions to move more readily through the anode material, reducing transport limitations that could otherwise limit battery performance. The enhanced lithium diffusivity provided by these secondary phases may enable more uniform lithium distribution throughout the anode structure, preventing localized lithium concentration gradients that could lead to mechanical stress or electrochemical inefficiencies.

The electrochemical compatibility between the aluminum majority phase and the secondary phases may be enhanced through the selection of secondary phase elements that alloy with lithium at redox potentials higher than aluminum. Elements such as indium, bismuth, and tin may remain lithiated during portions of the charge-discharge cycle when aluminum undergoes dealloying processes. This electrochemical behavior may help maintain structural continuity within the multiphase foil anode by preserving lithiated secondary phases that can accommodate mechanical stresses during aluminum dealloying operations.

During discharge operations, the multiphase foil anode may undergo coordinated dealloying processes where lithium ions are extracted from both the aluminum majority phase and the secondary phases. The dealloying sequence may be influenced by the relative redox potentials of the different alloying elements, with elements having lower redox potentials dealloying before those with higher redox potentials. The secondary phases with higher redox potentials may provide structural support during the initial stages of aluminum dealloying, helping to maintain anode integrity during the transition from lithiated to delithiated states.

The mechanical properties of the secondary phases may contribute to the accommodation of volume changes that occur during lithium insertion and extraction processes. Soft and deformable secondary phase elements, such as indium, lead, and tin, may form interconnected structures within the aluminum matrix that can accommodate the volume expansion and contraction associated with lithium alloying and dealloying. These secondary phases may distribute mechanical stresses more effectively throughout the anode structure, reducing the likelihood of crack formation or structural failure during repeated charge-discharge cycles.

The interconnected laminar structure formed by deformable secondary phases may provide mechanical pathways that allow the multiphase foil anode to maintain structural integrity during cycling operations. The laminar structure may enable sliding and deformation mechanisms that accommodate volume changes without creating excessive mechanical stress within the aluminum majority phase. This mechanical accommodation may help preserve the electrical connectivity between different regions of the anode and maintain stable electrochemical performance throughout extended cycling operations.

The functional integration of multiple secondary phase elements may provide synergistic effects that enhance overall anode performance beyond the individual contributions of each element. For example, the combination of indium and lead secondary phases may provide both enhanced lithium diffusivity from indium and improved mechanical deformability from lead, creating a multiphase foil anode with superior electrochemical and mechanical properties compared to anodes containing only single secondary phase element.

The operational performance of the multiphase foil anode may be optimized through the careful selection of secondary phase element concentrations that balance electrochemical enhancement with structural stability. The secondary phase concentrations may be selected to provide sufficient performance improvements while maintaining the predominant characteristics of the aluminum majority phase. This balance may ensure that the multiphase foil anode retains the beneficial properties of aluminum, such as low density and good electrical conductivity, while gaining enhanced lithium storage capacity, improved lithium transport, and better mechanical accommodation of volume changes during cycling operations.

The cycling performance of the multiphase foil anode may improve over multiple charge-discharge cycles as the secondary phases establish stable structural arrangements within the aluminum matrix. The initial cycles may involve structural reorganization of the secondary phases as they accommodate the mechanical and electrochemical stresses associated with lithium insertion and extraction. Subsequent cycles may benefit from the stabilized secondary phase structure, leading to improved Coulombic efficiency and capacity retention as demonstrated by the approach to 100% Coulombic efficiency after initial formation cycles.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 wt. %” is intended to mean “about 40 wt. %”.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A multiphase foil anode for a solid-state battery, comprising:
a foil comprising aluminum as a majority phase; and
a plurality of secondary phases dispersed within the aluminum majority phase, wherein the plurality of secondary phases comprises at least two different elements selected from the group consisting of indium, lead, bismuth, tin, gallium, zinc, lithium, and silicon.

2. The multiphase foil anode of claim 1, wherein the aluminum majority phase comprises at least 90 weight percent of the foil.

3. The multiphase foil anode of claim 2, wherein the aluminum majority phase comprises at least 95 weight percent of the foil.

4. The multiphase foil anode of claim 1, wherein the plurality of secondary phases comprises indium and lead.

5. The multiphase foil anode of claim 4, wherein the foil comprises aluminum in an amount of 95 weight percent, indium in an amount of 2.5 weight percent, and lead in an amount of 2.5 weight percent.

6. The multiphase foil anode of claim 1, wherein the plurality of secondary phases comprises indium and silicon.

7. The multiphase foil anode of claim 1, wherein at least one element of the plurality of secondary phases alloys with lithium at a redox potential higher than aluminum.

8. A multiphase aluminum-based foil anode for a solid-state battery, comprising:
an aluminum matrix forming a majority phase of the foil;
indium particles dispersed within the aluminum matrix; and
lead particles dispersed within the aluminum matrix, wherein the aluminum comprises at least 90 atomic percent of the foil composition.

9. The multiphase aluminum-based foil anode of claim 8, wherein the aluminum comprises at least 95 atomic percent of the foil composition.

10. The multiphase aluminum-based foil anode of claim 8, wherein the indium particles comprise between 1 and 5 atomic percent of the foil composition.

11. The multiphase aluminum-based foil anode of claim 10, wherein the lead particles comprise between 1 and 5 atomic percent of the foil composition.

12. The multiphase aluminum-based foil anode of claim 11, wherein the indium particles comprise 2.5 atomic percent and the lead particles comprise 2.5 atomic percent of the foil composition.

13. The multiphase aluminum-based foil anode of claim 8, wherein the indium particles and lead particles form secondary phases with an interconnected laminar structure within the aluminum matrix.

14. The multiphase aluminum-based foil anode of claim 8, wherein the indium and lead alloy with lithium at redox potentials higher than aluminum.

15. A solid-state battery, comprising:
a cathode comprising an active cathode material;
a solid-state electrolyte; and
a multiphase foil anode comprising aluminum as a majority phase and at least two secondary alloying elements selected from indium, lead, bismuth, tin, gallium, zinc, lithium, and silicon.

16. The solid-state battery of claim 15, wherein the at least two secondary alloying elements comprise indium and lead.

17. The solid-state battery of claim 16, wherein the multiphase foil anode comprises lead in an amount of up to 4 weight percent.

18. The solid-state battery of claim 17, wherein the multiphase foil anode comprises indium in an amount of up to 2.5 weight percent.

19. The solid-state battery of claim 18, wherein the multiphase foil anode comprises aluminum in an amount of 95 weight percent, indium in an amount of 2.5 weight percent, and lead in an amount of 2.5 weight percent.

20. The solid-state battery of claim 15, wherein the multiphase foil anode exhibits an initial Coulombic efficiency of at least 80%.
